(19) United States
(12) Patent Application Publication
(10) Pub. No.: US 2026/0316032 A1
(43) Pub. Date: Oct. 15, 2026

(54) FLUIDIZED-BED REACTOR FOR THE GAS-PHASE POLYMERIZATION OF OLEFINS

(71) Applicant: Basell Poliolefine Italia S.r.l., Milano (IT)

(72) Inventors: Enrico Balestra, Ferrara (IT); Giulia Mei, Ferrara (IT); Riccardo Rinaldi, Ferrara (IT); Gian Luca Bonaccorsi, Ferrara (IT); Giuseppe Penzo, Curtatone (IT); Maurizio Dorini, Ferrara (IT)

(73) Assignee: Basell Poliolefine Italia S.r.l., Milano (IT)

(21) Appl. No.: 19/109,368

(22) PCT Filed: Sep. 8, 2023
(86) PCT No.: PCT/EP2023/074719

§ 371 Date: Mar. 6, 2025

(30) Foreign Application Priority Data
Sep. 12, 2022 (EP) 22195187.4

(51) Int. Cl. B01J 8/44; B01J 8/18

(52) U.S. Cl. CPC B01J 8/44; B01J 8/1809; B01J 8/1818; B01J 8/1872; B01J 2208/00168

(57) ABSTRACT

A fluidized-bed reactor for the gas-phase polymerization of olefins includes (a) an inner chamber with lower and upper portions, (b) a gas distribution grid inside the chamber, partially separating the lower and upper sections, and (c) a recycle line, which feeds fluidizing gas to the lower portion, with the recycle line's first end connected to the upper portion. The gas distribution grid has multiple openings, including some openings located within 30 mm of the chamber's inner surface.

### FIELD OF THE DISCLOSURE

In general, the present disclosure relates to the field of chemistry. More specifically, the present disclosure relates to polymer chemistry. In particular, the present disclosure relates to a fluidized-bed reactor for the gas-phase polymerization of olefins and a process of preparing an olefin polymer.

### BACKGROUND OF THE DISCLOSURE

Gas-phase polymerization processes are economical processes for the preparation of polyolefins such as homopolymers of ethylene or propylene or copolymers of ethylene or propylene with other olefins. In some instances, fluidized-bed reactors are used for carrying out such processes. These reactors contain a bed of polymer particles which is maintained in a fluidized state by an upward flow of a fluidizing gas. In some instances, the reactors include, among other things, a reactor space in the form of an inner chamber of a vertical cylinder. In some instances, these reactors have a recycle gas line. In some instances, the recycle gas line includes coolers for removing the heat of polymerization, a recycle gas compressor, and optionally further elements such as a cyclone for removing fine polymer dust. In some instances, monomers consumed by the polymerization reaction are replaced by adding make-up gas to the recycle gas stream.

To achieve a homogeneous distribution of the fluidizing gas in the bed of growing polymer particles, some reactors are equipped with a gas distribution grid. In some instances, the gas distribution grid is alternatively referred to as gas fluidization grid or distribution plate. A gas distribution grid is a device provided with openings which dispense a gas stream into the bed. The gas stream is introduced under the grid. The grid also acts as support for the bed when the supply of gas is cut off.

In some instances, the gas distribution grid is configured as a perforated or porous plate. In some instances, the perforated or porous plate is in combination with an upstream flow divider. In some instances, roof-shaped deflector plates are arranged above the openings in the distributor plate. In some instances, the openings are covered with a cap. In some instances, the geometry of the gas distribution grid deviates from a plate.

In some instances, the fines present in the fluidizing gas accumulate in the space under the reactor grid, thereby developing polymer agglomerates. In some instances, the polymer agglomerates obstruct the grid openings, thereby jeopardizing the operability and reliability of the reactor system.

### SUMMARY OF THE DISCLOSURE

In a general embodiment, the present disclosure provides a fluidized-bed reactor for the gas-phase polymerization of olefins. In some embodiments, the present disclosure provides a process of preparing an olefin polymer.

### BRIEF DESCRIPTION OF THE FIGURES

FIG. 1 shows a schematic and side view of a fluidized-bed reactor.

FIG. 2 shows a plan view of part of the fluidized-bed reactor in FIG. 1.

FIG. 3 shows a lateral cross-section of part of the fluidized-bed reactor in FIG. 1.

FIG. 4 shows a front cross-section of a part of the fluidized-bed reactor's part in FIG. 3;

FIG. 5 shows a lateral cross-section of a part of the fluidized-bed reactor's part in FIG. 4.

### DETAILED DESCRIPTION OF THE DISCLOSURE

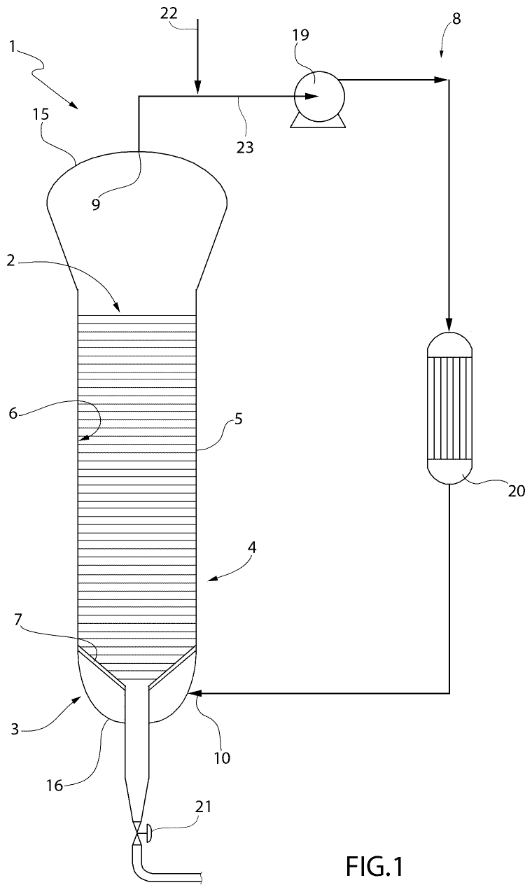

With reference to FIG. 1, the numeral 1 indicates as a whole a fluidized-bed reactor for the gas-phase polymerization of olefins. In some embodiments, the fluidized-bed reactor 1 has an inner chamber 2, having at least one lower portion 3 and at least one upper portion 4. In some embodiments, the fluidized-bed reactor 1 has at least one lateral wall 5, having an inner surface 6 delimiting the inner chamber 2 laterally (at least partially); a gas distribution grid 7, located inside the inner chamber 2 and which (at least partially) separates the lower portion 3 from the upper portion 4; and a recycle line 8, having a first end 9 connected to the inner chamber 2 at the upper portion 4 and a second end 10 connected to the inner chamber 2 at the lower portion 3.

In some embodiments, olefins for polymerization in the fluidized-bed reactor are 1-olefins, that is, hydrocarbons having terminal double bonds, without being restricted thereto. In some embodiments, the olefins are nonpolar olefinic compounds. In some embodiments, the 1-olefins are linear C₂-C₁₂-1-alkenes, branched C₂-C₁₂-1-alkenes, conjugated and nonconjugated dienes. In some embodiments, the linear C₂-C₁₂-1-alkenes are linear C₂-C₁₀-1-alkenes. In some embodiments, the linear C₂-C₁₀-1-alkenes are selected from the group consisting of ethylene, propylene, 1-butene, 1-pentene, 1-hexene, 1-heptene, 1-octene, and 1-decene. In some embodiments, the branched C₂-C₁₂-1-alkenes are branched C₂-C₁₀-1-alkenes. In some embodiments, the branched C₂-C₁₀-1-alkenes are 4-methyl-1-pentene. In some embodiments, the dienes are selected from the group consisting of 1 ,3-butadiene, 1 ,4-hexadiene, and 1 ,7-octadiene. In some embodiments, mixtures of various 1-olefins are polymerized. In some embodiments, the olefins have the double bond as part of a cyclic structure. In some embodiments, the cyclic structure has one or more ring systems. In some embodiments, the olefins, including a cyclic structure, are selected from the group consisting of cyclopentene, norbornene, tetracyclododecene, methylnorbornene, 5-ethylidene-2-norbornene, norbornadiene, and ethylnorbornadiene. In some embodiments, mixtures of two or more olefins are polymerized.

As used herein, the term “Cₓ-C_{y}” refers to a group, a compound, or both, which is intended as having x to y carbon atoms.

In some embodiments, the fluidized-bed reactor 1 is for the homopolymerization or copolymerization of ethylene or propylene. In some embodiments, the reactor is for the homopolymerization or copolymerization of ethylene. In some embodiments, comonomers in propylene polymerization are up to 40 wt. %, alternatively from 0.5 wt. % to 35 wt. %, of ethylene, 1-butene, 1-hexene, or a combination thereof. In some embodiments, comonomers in ethylene polymerization are up to 20 wt. %, alternatively from 0.01 wt. % to 15 wt. %, alternatively from 0.05 wt. % to 12 wt. %, of C₃-C₈-1-alkenes. In some embodiments, the C₃-C₈-1-alkenes are selected from the group consisting of 1-butene, 1-pentene, 1-hexene and 1-octene. In some embodiments, ethylene is copolymerized with from 0.1 wt. % to 12 wt. % of 1-hexene, 1-butene, or both.

In some embodiments, the polymerization is carried out in the presence of an inert gas such as nitrogen or an alkane having from 1 to 10 carbon atoms. In some embodiments, the alkane is selected from the group consisting of methane, ethane, propane, n-butane, isobutane, n-pentane, isopentane, n-hexane, and mixtures thereof. In some embodiments, the inert gas is nitrogen or propane. In some embodiments, the inert gas is nitrogen or propane in combination with further alkanes. In some embodiments, the polymerization is carried out in the presence of a C₃-C₅ alkane as polymerization diluent, alternatively in the presence of propane. In some embodiments, the polymerization is for the homopolymerization or copolymerization of ethylene. In some embodiments, the reaction gas mixtures within the reactor additionally are made from or containing the olefins to be polymerized, that is, the monomer and one or more optional comonomers. In some embodiments, the reaction gas mixture has a content of inert components from 30 to 99 vol. %, alternatively from 40 to 95 vol. %, alternatively from 45 to 85 vol. %. In some embodiments, the monomer is propylene and the reaction gas mixture is free of an added inert diluent, alternatively minor amounts of inert diluent are added. In some embodiments, the reaction gas mixture is further made from or containing components such as antistatic agents or molecular weight regulators like hydrogen. In some embodiments, the components of the reaction gas mixture are fed into the gas-phase polymerization reactor or into the recycle gas line in gaseous form or as a liquid which vaporizes within the reactor or the recycle gas line.

In some embodiments, the polymerization of olefins is carried out in the presence of olefin polymerization catalysts. In some embodiments, the polymerization is carried out using Phillips catalysts based on chromium oxide, using Ziegler or Ziegler-Natta-catalysts, or using single-site catalysts. As used herein, single-site catalysts are catalysts based on chemically uniform transition metal coordination compounds. In some embodiments, mixtures of two or more of these catalysts are used for the polymerization of olefins. In some embodiments, mixed catalysts are referred to as hybrid catalysts.

In some embodiments, catalysts of the Ziegler type are made from or containing a compound of titanium or vanadium, a compound of magnesium, and optionally an electron donor compound, a particulate inorganic oxide as a support material, or both.

In some embodiments, catalysts of the Ziegler type are used in the presence of a cocatalyst. In some embodiments, the cocatalysts are organometallic compounds of metals of Groups 1,2, 12, 13 or 14 of the Periodic Table of Elements, alternatively organometallic compounds of metals of Group 13, alternatively organoaluminum compounds. In some embodiments, cocatalysts are selected from the group consisting of organometallic alkyls, organometallic alkoxides, and organometallic halides.

In some embodiments, organometallic compounds are selected from the group consisting of lithium alkyls, magnesium alkyls, zinc alkyls, magnesium alkyl halides, aluminum alkyls, silicon alkyls, silicon alkoxides and silicon alkyl halides. In some embodiments, the organometallic compounds are selected from the group consisting of aluminum alkyls and magnesium alkyls. In some embodiments, the organometallic compounds are aluminum alkyls, alternatively trialkylaluminum compounds. In some embodiments, the organometallic compounds are aluminum alkyls, wherein an alkyl group is replaced by a halogen atom. In some embodiments, the halogen atom is chlorine or bromine. In some embodiments, the aluminum alkyls are selected from the group consisting of trimethylaluminum, triethylaluminum, tri-isobutylaluminum, tri-n-hexylaluminum, diethylaluminum chloride, and mixtures thereof.

In some embodiments, the fluidized-bed reactor is operated at pressures of from 0.5 MPa to 10 MPa, alternatively from 1.0 MPa to 8 MPa, alternatively from 1.5 M Pa to 4 M Pa. In some embodiments, the polymerization is carried out at temperatures of from 30 °C to 60 °C, alternatively from 65 °C to 125 °C. In some embodiments, the temperatures in the upper part of this range are for preparing ethylene copolymers of relatively high density. In some embodiments, the temperatures in the lower part of this range are for preparing ethylene copolymers of lower density.

In some embodiments, the polymerization in the fluidized-bed reactor is also carried out in a condensing or super-condensing mode, wherein part of the circulating reaction gas mixture is cooled to below the dew point and returned to the reactor (a) separately as a liquid and a gas or (b) together as a liquid-gas phase mixture, thereby making additional use of the enthalpy of vaporization for cooling the reaction gas.

With reference to FIG. 1, the gas recycle line 8 is configured to feed a fluidizing gas, made from or containing a recycled part (taken from the inner chamber 2) and fresh olefins monomers (added along the gas recycle line 8), to the lower portion 3 of the inner chamber 2. In some embodiments, the recycle part is made from or containing unreacted, partially reacted, or both olefin monomers.

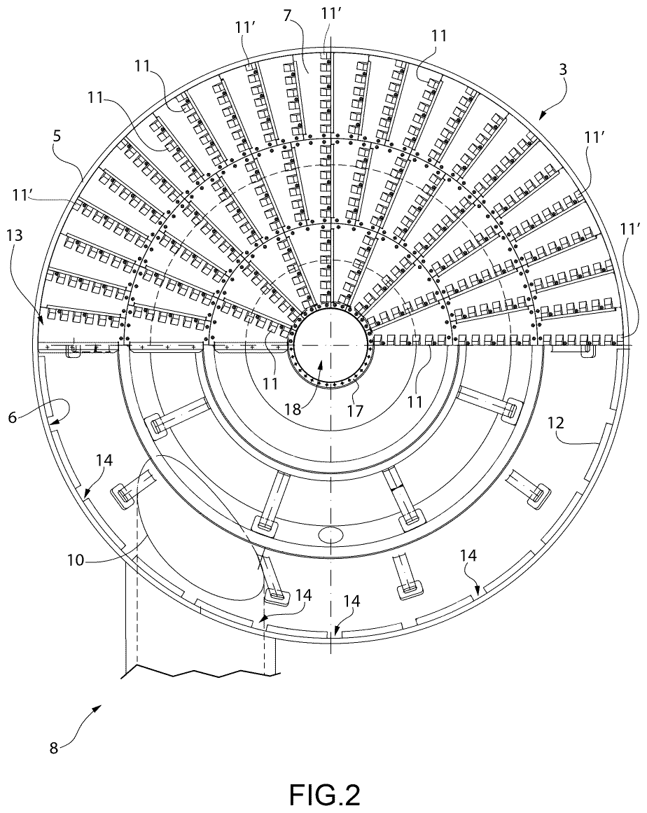

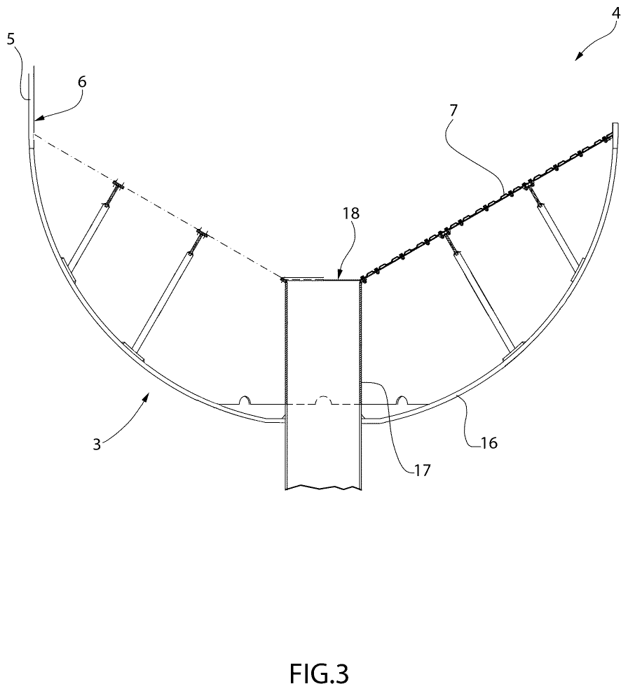

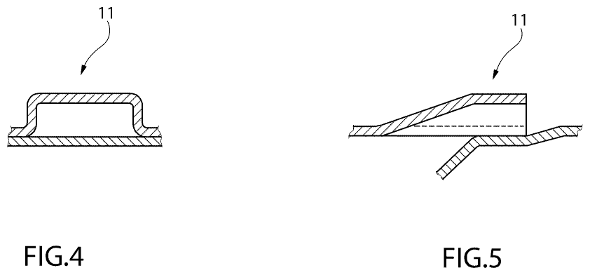

With reference to FIG. 2, the gas distribution grid 7 has a plurality of openings, which are configured for the passage of the fluidizing gas from the lower portion 3 to the upper portion 4 of the inner chamber 2, has a plurality of first openings 11 located at more than 30 mm, alternatively at more than 40 mm, alternatively at more than 80 mm, from the inner surface 6 of the lateral wall 5, and has second openings 11′ located at less than 30 mm, alternatively at less than 20 mm, alternatively at less than 5 mm, from the inner surface 6 of the lateral wall 5.

In some embodiments, there is a reduced development of polymer agglomerates inside the lower portion 3. In some embodiments, there is a reduced development of polymer agglomerates in the area between a peripheral edge of the grid 7 and the lateral wall 5.

In some embodiments, the fluidized-bed reactor 1 has a lateral support 12, which extends (in a loop) along the inner surface 6 and in contact with the inner surface 6 (and—at least partially—supports the gas distribution grid 7). The gas distribution grid 7 has a peripheral edge 13, which is positioned (at least) partially on, alternatively rests on, and is in contact with the lateral support 12. The lateral support 12 has apertures 14, each of which is positioned at under a corresponding second opening 11′ and configured for the passage of the fluidizing gas from the lower portion 3 to the upper portion 4 of the inner chamber 2 through the corresponding second opening 11′. In some embodiments, the grid 7 has mechanical stability, without hindering the passage through the openings.

In some embodiments, the lateral support 12 has a width (measured from the inner surface 6 towards the center of the inner chamber 2) of at least 2 cm, alternatively at least 3 cm. In some embodiments, the width (measured from the inner surface 6 towards the center of the inner chamber 2) is up to 6 cm, alternatively up to 4 cm.

With reference to FIG. 2, a part (about one half) of the grid 7 is depicted, thereby showing the structure of the lateral support 12.

In some embodiments, the apertures 14 are at least as big as the openings. In some embodiments, the apertures 14 have a length of at least 40 mm, alternatively at least 50 mm, alternatively at least 70 mm, alternatively up to 200 mm, alternatively up to 150 mm, alternatively up to 100 mm.

In some embodiments, the apertures 14 are complete interruptions (gaps) of the lateral support 12. In other words, the apertures 14 are open—not delimited—towards the center of the inner chamber 2. In some embodiments, the lateral support 12 is absent—not even partially present at the apertures 14 (a first stretch of the lateral support 12 ends just upstream from—before—an aperture 14 and a second stretch thereof starts just downstream from—after—such an aperture 14).

In some embodiments, the openings are formed such that the flow of the fluidizing gas, after having passed the openings, is parallel to a plane of the gas distribution grid 7, alternatively tangential to the gas distribution grid 7, alternatively horizontal.

In some embodiments, the openings are slots. In some embodiments, the width of the slots (openings) is more than the slots' height, alternatively more than the double of the slots' height.

In some embodiments, the openings are at least 3 mm wide. In some embodiments, the width is in the direction from the inner surface 6 towards the center of the inner chamber 2. In some embodiments, the openings are at most 10 cm wide, alternatively at most 5 cm wide.

In some embodiments, the openings are made as described in Patent Cooperation Treaty Publication No. WO2008074632.

In some embodiments, the openings are at least ten, alternatively at least one hundred.

In some embodiments, the openings include groups of openings aligned one with respect of the others. In some embodiments, the groups of openings are aligned radially with respect to an axis of the inner chamber 2. In other words, the openings of one group are aligned one with respect of the others. In some embodiments and in other words, the openings of one group are aligned radially with respect to an axis of the inner chamber 2.

In some embodiments, the fluidized-bed reactor 1 has an upper wall 15, which delimits a top of the inner chamber 2 and is connected to the lateral wall 5, and a lower wall 16, which delimits a bottom of the inner chamber 2 and is connected to the lateral wall 5.

In some embodiments although not depicted in the figures, the gas recycle line 8 is configured to convey the recycled part of the fluidizing gas from the upper portion 4 of the inner chamber 2 through the upper wall 15 and the fluidizing gas through the lateral wall 5 to the lower portion 3.

In some embodiments, the fluidized-bed reactor 1 further has a polymer discharge pipe 17, which has an upper opening 18 integrated into the gas distribution grid 7. In some embodiments, the upper opening 18 of the polymer discharge pipe 17 is arranged in the center of the gas distribution grid 7. In some embodiments, the polymer discharge pipe 17 is configured to discharge the polymer produced inside the upper portion 4.

In some embodiments, the discharge pipe 17 has a regulator 21, such as a discharge valve, configured to adjust the mass flow rate of polymer discharged from the reactor 1. In some embodiments, the opening of the regulator 21 is continuously adjusted, thereby maintaining the height of the fluidized polymer bed inside the reactor constant.

In some embodiments, the discharge pipe 17 has a uniform diameter. In some embodiments, the discharge pipe 17 has more sections having decreasing diameters in the downward direction. In some embodiments, the regulator 21 is placed in the area of, alternatively at, a restriction between a section of higher diameter and a section of lower diameter as shown in FIG. 1.

In some embodiments, the discharge system is as described in Patent Cooperation Treaty Publication No. WO2007071527A1.

In some embodiments, the gas recycle line 8 is provided with a heat exchanger 20, which is configured to reduce the heat of the recycled part. In some embodiments, the gas recycle line 8 is provided with a compressor 19 and a heat exchanger 20.

In some embodiments, the recycle line 8 is provided with a topping up line 22 for feeding the fresh olefins monomers, molecular weight regulators and optionally inert gases. In some embodiments, the topping line 22 also feeds other components selected from the group consisting of antistatic agents and mileage improvers. In some embodiments, the topping up line 22 feeds to a main pipe 23 of the recycle line 8. In some embodiments, the topping up line 22 is configured to feed upstream from the heat exchanger 20, alternatively between the upper portion 4 and the compressor 19, alternatively upstream from the compressor 19.

In some embodiments, the gas distribution grid 7 has the form of a lateral surface of a truncated cone, alternatively a truncated and inverted cone.

In some embodiments, the fluidized-bed reactor 1 is as described in and operates as described in Patent Cooperation Treaty Publication No. WO2008074632.

In some embodiments, the present disclosure provides a process for preparing an olefin polymer including the step of homopolymerizing an olefin or copolymerizing an olefin and one or more other olefins in the presence of a polymerization catalyst, wherein the polymerization is carried out in the fluidized-bed reactor 1. In some embodiments, the step of homopolymerizing an olefin or copolymerizing an olefin and one or more other olefins occurs at temperatures of from 20 to 200 °C. In some embodiments, the step of homopolymerizing an olefin or copolymerizing an olefin and one or more other olefins occurs at pressures of from 0.5 to 10 MPa.

In some embodiments, the fluidized-bed reactor 1 has a polymer discharge pipe 17, through which the polymer is continuously discharged.

In some embodiments, the polymerization conditions are for olefin polymerization in gas-phase reactors. In some embodiments, the polymerization temperature ranges from 60 to 120 °C. In some embodiments, the polymerization pressure ranges from 5 to 40 bar. In some embodiments, the gas-phase polymerization process is combined with slurry, bulk, or gas-phase polymerization processes, thereby carrying out a sequential multistage polymerization process. In some embodiments, one or more polymerization stages operating in a loop reactor, a fluidized bed reactor, or a stirred bed reactor are upstream or downstream the fluidized-bed reactor. In some embodiments, gas-phase polymerization reactors, having interconnected polymerization zones as described in European Patent Nos. EP 782 587 and EP 1012195, are arranged upstream or downstream the fluidized-bed reactor.

In some embodiments, the gas-phase polymerization process allows the preparation of olefin powders, having a particle size distribution with a low content of fines. In some embodiments, the [alpha]-olefins have the formula CH₂═CHR, where R is hydrogen or a hydrocarbon radical having 1-12 carbon atoms. In some embodiments, the resulting polymers are selected from the group consisting of
high-density polyethylenes (HDPEs, having relative densities higher than 0.940) including ethylene homopolymers and ethylene copolymers with [alpha]-olefins having 3 to 12 carbon atoms; linear polyethylenes of low density (LLDPEs, having relative densities lower than 0.940) and of very low density and ultra low density (VLDPEs and ULDPEs, having relative densities lower than 0.920 down to 0.880) consisting of ethylene copolymers with one or more [alpha]-olefins having 3 to 12 carbon atoms;
elastomeric terpolymers of ethylene and propylene with minor proportions of diene or elastomeric copolymers of ethylene and propylene with a content of units derived from ethylene of between about 30 and 70% by weight;
isotactic polypropylene and crystalline copolymers of propylene and ethylene, other [alpha]-olefins, or both, having a content of units derived from propylene of more than 85% by weight; isotactic copolymers of propylene and [alpha]-olefins, such as 1-butene, with an [alpha]-olefin content of up to 30% by weight;
impact-resistant propylene polymers obtained by sequential polymerization of propylene and mixtures of propylene with ethylene containing up to 30% by weight of ethylene; and
atactic polypropylene and amorphous copolymers of propylene and ethylene, other [alpha]-olefins, or both, containing more than 70% by weight of units derived from propylene.

In some embodiments, the gas-phase polymerization process is in the presence of various polymerization catalysts. In some embodiments, the process is implemented in an exothermic polymerization reaction employing various catalysts. In some embodiments, the catalyst is supported or unsupported. In some embodiments, the catalyst is in pre-polymerized form.

In some embodiments, the polymerization reaction is carried out in the presence of highly active catalytic systems. In some embodiments, the catalyst systems are selected from the group consisting of Ziegler-Natta catalysts, single site catalysts, chromium-based catalysts, and vanadium-based catalysts.

Unless expressly indicated to the contrary, the content of the references (articles, books, patent applications, etc.) cited in this text is recalled in full herein. The above-mentioned references are incorporated herein by reference.

What is claimed is:

1. A fluidized-bed reactor for the gas-phase polymerization of olefins comprising:
an inner chamber, having at least one lower portion and at least one upper portion;
at least one lateral wall, having an inner surface delimiting the inner chamber laterally at least partially;
a gas distribution grid, located inside the inner chamber and which at least partially separates the lower portion from the upper portion; and
a recycle line, having a first end connected to the inner chamber at the upper portion of the inner chamber and a second end connected to the inner chamber at the lower portion of the inner chamber;
wherein the recycle line is configured to feed a fluidizing gas comprising recycled—unreacted, partially reacted, or both olefin monomers and fresh olefin monomers, to inner chamber at the lower portion;
the gas distribution grid comprising a plurality of openings, which are configured for the passage of the fluidizing gas from the lower portion to the upper portion of the inner chamber; and
the openings comprise a plurality of first openings located at more than 30 mm from the inner surface of the lateral wall and a plurality of second openings located at less than 30 mm from the inner surface of the lateral wall.

2. The fluidized-bed reactor according to claim 1, wherein the second openings are at less than 20 mm from the lateral wall.

3. The fluidized-bed reactor according to claim 1, wherein the second openings are at less than 5 mm from the lateral wall.

4. The fluidized-bed reactor according to claim 1, further comprising a lateral support, which extends along the inner surface and in contact with the inner surface;
wherein the gas distribution grid has a peripheral edge, positioned at least partially in contact with the lateral support; and
the lateral support has apertures, each of which is positioned at a corresponding second opening and configured for the passage of the fluidizing gas from the lower portion to the upper portion of the inner chamber through the corresponding second opening.

5. The fluidized-bed reactor according to claim 4, wherein the apertures are complete interruptions of the lateral support.

6. The fluidized-bed reactor according to claim 1, wherein the openings are formed such that the flow of the fluidizing gas, after having passed the openings, is parallel to a plane of the gas distribution grid.

7. The fluidized-bed reactor according to claim 1, wherein the openings are slots and are at least 3 mm wide.

8. The fluidized-bed reactor according to claim 1, wherein the openings are at most 10 cm wide.

9. The fluidized-bed reactor according to claim 1, further comprising
an upper wall, which delimits a top of the inner chamber and is connected to the lateral wall; and
a lower wall, which delimits a bottom of the inner chamber and is connected to the lateral wall;
wherein the recycle line being configured to convey the recycled part of the fluidizing gas from the upper portion of the inner chamber through the upper wall and the fluidizing gas to the lower portion.

10. The fluidized-bed reactor according to claim 1, further comprising
a polymer discharge pipe, comprising an upper opening integrated into the gas distribution grid.

11. The fluidized-bed reactor according to claim 1, wherein the recycle line is provided with a heat exchanger, configured to reduce the heat of the recycled part.

12. The fluidized-bed reactor according to claim 1, wherein the gas distribution grid has the shape of a lateral surface of a truncated cone.

13. A process of preparing an olefin polymer comprising the step of:
homopolymerizing an olefin or copolymerizing an olefin and one or more other olefins in the presence of a polymerization catalyst, wherein the polymerization is carried out in the fluidized-bed reactor according to claim 1.

14. The process according to claim 13, wherein the fluidized-bed reactor comprises a polymer discharge pipe, through which the polymer is continuously discharged.
